(19) United States
(12) Patent Application Publication
(10) Pub. No.: US 2013/0002510 A1
(43) Pub. Date: Jan. 3, 2013

(54) ANTENNAS WITH NOVEL CURRENT DISTRIBUTION AND RADIATION PATTERNS, FOR ENHANCED ANTENNA ISLATION

(75) Inventors: Snir Azulay, Tiberias (IL); Matti Martiskainen, Tiberias (IL)

(73) Assignee: GALTRONICS CORPORATION LTD., Tiberias (IL)

(21) Appl. No.: 13/576,117

(22) PCT Filed: Feb. 17, 2011
(86) PCT No.: PCT/IL2011/000169

§ 371 Date: Sep. 10, 2012

Related U.S. Application Data
(60) Provisional application No. 61/338,378, filed on Feb. 17, 2010.

(51) Int. Cl. H01Q 5/00; H01Q 1/50; H01Q 21/00

(52) U.S. Cl. 343/860; 343/700 MS; 343/893

(57) ABSTRACT

An antenna including a ground plane, at least one first conductive element located in proximity to an edge of the ground plane and having first and second ends, the first end extending generally parallel to the ground plane, the second end in contact with a feed point, and at least one second conductive element located in proximity to the edge of the ground plane and having first and second ends, the first end extending generally parallel to the ground plane and to the first end of the at least one first conductive element, the second end in contact with the ground plane.

### REFERENCE TO RELATED APPLICATIONS

Reference is hereby made to U.S. Provisional Patent Application 61/338,378, entitled INDUCED CANCELLATION ANTENNA TECHNOLOGY, filed Feb. 17, 2010, the disclosure of which is hereby incorporated by reference and priority of which is hereby claimed pursuant to 37 CFR 1.78(a)(4) and (5)(i).

### FIELD OF THE INVENTION

The present invention relates generally to antennas and more particularly to antennas for use in wireless communication devices.

### BACKGROUND OF THE INVENTION

The following publications are believed to represent the current state of the art:

‘MIMO Antenna Design for Small Handheld Devices’, Q. Rao, Research in Motion Ltd., IWPC Workshop, Sweden (2009);

‘Multiband MIMO Antenna with a Band Stop Matching Circuit for Next Generation Mobile Applications’, M. Han et. al., PIERS Proceedings, Russia (2009);

‘Study and Reduction of the Mutual Coupling between Two Mobile Phone PIFAs Operating in the DCS1800 and UMTS Bands’, A. Diallo et. al., IEEE Transactions on Antennas and Propagation, Part 1, Vol. 54 (11), p. 3063-3074 (2006);

‘The High Isolation Dual-Band Inverted F Antenna Diversity System with the Small N-Section Resonators on the Ground Plane’, K. Kim et. al., Microwave and Optical Technology Letters, Vol. 49 (3), p. 731-734 (2007);

U.S. Pat. Nos. 7,825,863, 7,688,273 and 5,764,190; and

U.S. Published Application No.: 2010/0053022.

### SUMMARY OF THE INVENTION

The present invention seeks to provide a novel antenna particularly suited for incorporation in multiple-input multiple-output antenna systems, for use wireless communication devices.

There is thus provided in accordance with a preferred embodiment of the present invention an antenna, including a ground plane, at least one first conductive element located in proximity to an edge of the ground plane and having first and second ends, the first end extending generally parallel to the ground plane, the second end in contact with a feed point and at least one second conductive element located in proximity to the edge of the ground plane and having first and second ends, the first end extending generally parallel to the ground plane and to the first end of the at least one first conductive element, the second end in contact with the ground plane.

Preferably, the at least one first conductive element includes a folded monopole and the at least one second conductive element includes a parasitic element in capacitive and inductive contact with the first conductive element.

Preferably, the contact between the second end of the at least one second conductive element and the ground plane includes a galvanic contact.

Preferably, the at least one first and second conductive elements include strips of conductive material, the strips having a width and a length.

Preferably, the width is constant along the length. Alternatively, the width varies along the length.

Preferably, the feed point is located at the edge of the ground plane.

In accordance with a preferred embodiment of the present invention, the ground plane and the at least one first and second conductive elements are formed on a surface of a dielectric substrate.

Preferably, the dielectric substrate includes a PCB substrate.

In accordance with another preferred embodiment of the present invention, an impedance of the second end of the at least one first conductive element matches a 50 Ohm input impedance.

Preferably, the antenna does not include a matching network.

Preferably, an electric field generated by currents on the ground plane is concentrated at edges of the ground plane.

In accordance with still another preferred embodiment of the present invention, a multiple antenna system includes at least two of the antennas, wherein the ground plane includes a common ground plane.

Preferably, the multiple antenna system includes a MIMO system.

Additionally or alternatively, the multiple antenna system includes a 3GPP-LTE system.

Preferably, the multiple antenna system has planar geometry. Alternatively, the multiple antenna system has three-dimensional geometry.

Preferably, the at least one first and second conductive elements are mounted on a plastic carrier.

Preferably, the at least one first and second conductive elements are mounted on an external surface of the plastic carrier. Alternatively, at least one of the at least one first and second conductive elements are mounted on an internal surface of the plastic carrier.

In accordance with yet another preferred embodiment of the present invention, the multiple antenna system also includes at least one conductive element extending from the common ground plane, whereby at least one antenna in the multiple antenna system is capable of resonating in two frequency bands.

Preferably, the two frequency bands include a high frequency band and a low frequency band.

Preferably, the high frequency band includes frequencies between 1.7 and 2.2 GHz and the low frequency band includes frequencies between 698 and 960 MHz.

Preferably, the two frequency bands are mutually independent.

In accordance with still another preferred embodiment of the present invention, the multiple antenna system includes a USB dongle.

In accordance with a further preferred embodiment of the present invention the multiple antenna system also includes at least one conductive element galvanically connected to the ground plane and in capacitive contact with the first end of the at least one first conductive element, whereby a bandwidth of at least one frequency band of the antenna is widened.

In accordance with yet a further preferred embodiment of the present invention, the at least one first conductive element includes a branched conductive element and the at least one second conductive element is folded around the branched conductive element.

There is additionally provided in accordance with a preferred embodiment of the present invention a multiple antenna system, including a common ground plane and at least two antennas located in proximity to the common ground plane, each of the at least two antennas including at least one first conductive element located in proximity to an edge of the common ground plane and having first and second ends, the first end extending generally parallel to the common ground plane, the second end in contact with a feed point and at least one second conductive element located in proximity to the edge of the common ground plane and having first and second ends, the first end extending generally parallel to the common ground plane and to the first end of the at least one first conductive element, the second end in contact with the common ground plane.

There is further provided in accordance with a preferred embodiment of the present invention a method for impedance matching, including providing a ground plane, providing at least one first conductive element located in proximity to an edge of the ground plane and having a first end and a second end, the first end extending generally parallel to the ground plane, the second end in contact with a feed point and providing at least one second conductive element located in proximity to the edge of the ground plane and having a first end and a second end, the first end extending generally parallel to the ground plane and to the first end of the at least one first conductive element, the second end in contact with the ground plane, whereby an impedance of the second end of the at least one first conductive element is substantially increased.

Preferably, the at least one first conductive element includes a folded monopole.

Preferably, an impedance of the second end of the at least one first conductive element is equal to approximately 50 Ohms.

There is additionally provided in accordance with a preferred embodiment of the present invention a method for increasing isolation between co-located antennas in a handset or other small receiver device, including providing a common ground plane and providing at least two antennas located in proximity to the common ground plane, each of the at least two antennas including at least one first conductive element located in proximity to an edge of the common ground plane and having first and second ends, the first end extending generally parallel to the common ground plane, the second end in contact with a feed point and at least one second conductive element located in proximity to the edge of the common ground plane and having first and second ends, the first end extending generally parallel to the common ground plane and to the first end of the at least one first conductive element, the second end in contact with the common ground plane, whereby isolation between the at least two antennas is increased.

### BRIEF DESCRIPTION OF THE DRAWINGS

The present invention will be understood and appreciated more fully from the following detailed description, taken in conjunction with the drawings in which:

FIG. 1 is a schematic illustration of an antenna constructed and operative in accordance with a preferred embodiment of the present invention;

FIG. 2 is a schematic illustration of a multiple antenna system constructed and operative in accordance with a preferred embodiment of the present invention;

FIGS. 3A, 3B and 3C are simplified respective side, top and perspective view illustrations of a multiple antenna system, constructed and operative in accordance with another preferred embodiment of the present invention;

FIGS. 4A, 4B and 4C are simplified respective underside, top and perspective view illustrations of a multiple antenna system, constructed and operative in accordance with yet another preferred embodiment of the present invention;

FIGS. 5A and 5B are simplified respective top and perspective view illustrations of a multiple antenna system, constructed and operative in accordance with still another preferred embodiment of the present invention;

FIG. 6 is a schematic illustration of a multiple antenna system constructed and operative in accordance with a further preferred embodiment of the present invention;

FIG. 7A is a simplified graph showing a radiation pattern of an antenna in a multiple antenna system of the type illustrated in FIGS. 5A and 5B;

FIGS. 7B and 7C are simplified respective top and side view illustrations of an electric field distribution of an antenna in a multiple antenna system of the type illustrated in FIGS. 5A and 5B; and

FIGS. 7D, 7E and 7F are simplified graphs respectively showing the efficiency, return loss and isolation of an antenna in a multiple antenna system of the type illustrated in FIGS. 5A and 5B.

### DETAILED DESCRIPTION OF PREFERRED EMBODIMENTS

Reference is now made to FIG. 1, which is a schematic illustration of an antenna constructed and operative in accordance with a preferred embodiment of the present invention.

As seen in FIG. 1, there is provided an antenna 100, including a ground plane 102, in proximity to an edge of which ground plane 102 are located at least first and second conductive elements, here including a first conductive element 104 and a second conductive element 106. Ends of first and second conductive elements 104 and 106 are preferably bent so as to extend generally parallel to each other and to the ground plane 102. It is appreciated that although in the embodiment shown in FIG. 1 only first and second conductive elements 104 and 106 are shown, the inclusion of a additional conductive elements configured similarly to the first and second conductive elements 104 and 106 is also possible.

At least first and second conductive elements, such as elements 104 and 106, and ground plane 102 are preferably formed as flat elements on a surface of a rigid dielectric substrate 108 such as FR-4, such that antenna 100 may be considered to have a two-dimensional structure. It is appreciated, however, that at least one of first and second conductive elements, such as first and/or second conductive elements 104 and 106, may alternatively be supported in a plane perpendicular to the ground plane 102, thereby forming a three-dimensional antenna structure. Rigid dielectric substrate 108 preferably comprises a portion of a printed circuit board (PCB).

First and second conductive elements 104 and 106 are typically formed as strips of conductive material having a constant width along the strip of approximately 1 mm. However, embodiments of the present invention may use various and/or different widths of conductive material, preferably in the range of approximately 0.5 mm to approximately 4 mm. Furthermore, in some embodiments of the present invention, the width may be varied along the length of conductive elements 104 and 106.

First conductive element 104 is preferably connected at one of its ends 110 to a feed point 112 and thus may also be termed a feed element 104. Feed element 104 has a length equal to ¼λ and, due to its bent structure, resembles a folded monopole. Feed point 112 is preferably located at an edge of ground plane 102 and preferably feeds feed element 104 at an input impedance of 50 Ohms, although it is appreciated that antenna 100 may be configured so as to be compatible with other input impedances.

Second conductive element 106 is preferably galvanically connected at one of its ends to the ground plane 102 and is located in close proximity to feed element 104. Second conductive element 106 is a parasitic element, capacitively and inductively coupled to feed element 104, and hence may also be termed a coupling element 106.

In the operation of antenna 100, a radio-frequency (RF) signal is supplied to feed element 104 by way of feed point 112, causing feed element 104 to radiate and capacitive and inductive coupling to occur between feed element 104, coupling element 106 and the ground plane 102. It is a particular feature and advantage of the present invention that the presence of coupling element 106 serves more to increase the impedance at the end 110 of feed element 104 than to widen the operating bandwidth of feed element 104, as would typically be expected of a coupled parasitic element.

In the absence of coupling element 106, the impedance at the end of feed element 104 would be very low and a matching circuit between the feed element 104 and a 50 Ohm input impedance point would be required. The presence of coupling element 106 obviates the need for a matching circuit, although the optional inclusion of a matching network or of gamma matching may be advantageous for certain applications.

A further unique feature arising from the structure of antenna 100 is the antenna's current distribution on the ground plane 102. The radiation pattern of conventional antennas in handheld communication devices is typically similar to that of a simple dipole, being omnidirectional in the horizontal plane and toroidal. This pattern is created by currents traveling back and forth along the device PCB, as a result of which currents the antenna is able to utilize the self-resonance of the PCB and chassis. In contrast, simulations carried out using the antenna design of embodiments of the present invention show currents to be concentrated in the region of the feed and coupling elements 104 and 106 and at the edges of the ground plane 102 to which the feed and coupling elements are adjacent. This reduces the dependency of the resonant frequency of the antenna on the size and shape of the ground plane. Simulated radiation patterns of an antenna based on antenna 100 are presented below in the section entitled ‘Simulation Results’.

A possible advantageous exploitation of the altered current paths of antenna 100 is in multiple antenna systems, where this feature of antenna 100 leads to improved isolation between co-located antennas, as will be explained in more detail in reference to various multiple antenna system embodiments of the present invention, described herein below.

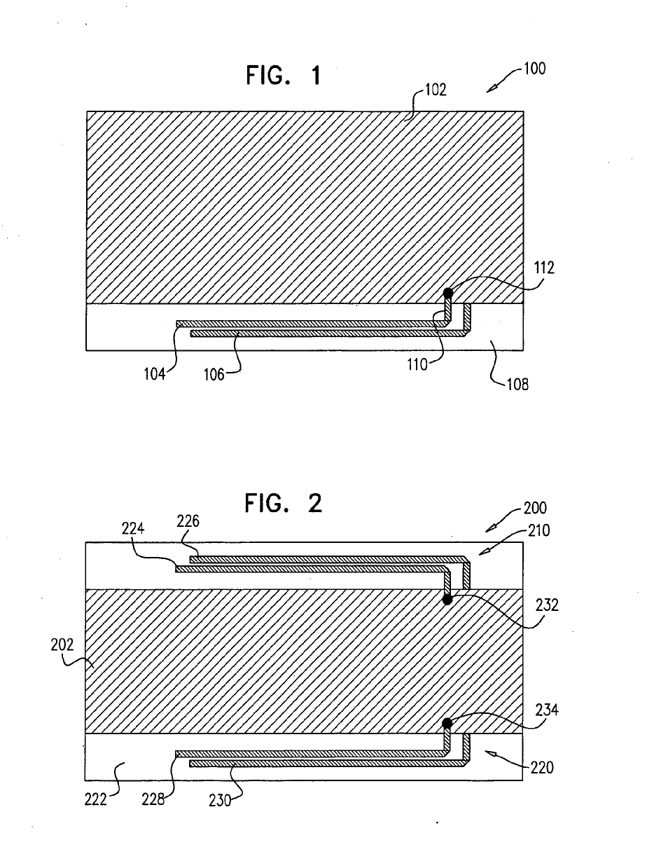

Reference is now made to FIG. 2, which is a schematic illustration of a multiple antenna system, constructed and operative in accordance with a preferred embodiment of the present invention.

As seen in FIG. 2, there is provided a multiple antenna system 200 including a ground plane 202, in proximity to an edge of which ground plane 202 are located a first radiating assembly 210 and a second radiating assembly 220. It is appreciated that although in the embodiment illustrated in FIG. 2 only two radiating assemblies 210 and 220 are shown, the present invention as illustrated in FIG. 2 may be easily modified by one skilled in the art to include a greater number of radiating assemblies located in proximity to ground plane 202. Ground plane 202 and radiating assemblies 210 and 220 are preferably formed on a surface of a rigid PCB substrate 222 such as FR-4.

Each of radiating assemblies 210 and 220 preferably comprises a pair of feed and coupling elements generally similar in their structure and operation to the feed and coupling elements of antenna 100. Radiating assembly 210 thus includes a conductive feed element 224 and a conductive coupling element 226 and radiating assembly 220 includes a conductive feed element 228 and a conductive coupling element 230. Feed element 224 is preferably fed at a feed point 232 and feed element 228 is preferably fed at a feed point 234. Other details pertaining to the individual elements of radiating assemblies 210 and 220 are as described above in reference to the analogous features of antenna 100.

Radiating assemblies 210 and 220 are preferably located adjacent to opposite edges of ground plane 202. Ground plane 202 thus acts as a common ground plane for both of radiating assemblies 210 and 220.

Radiating assemblies 210 and 220 are preferably configured to each radiate in a separate RF radiation channel, such that antenna system 200 constitutes a multiple-input multiple-output (MIMO) system. In conventional MIMO antenna systems in handheld devices, strong mutual coupling between closely spaced radiating assemblies tends to significantly limit achievable radiating efficiency. This strong mutual coupling is in part caused by the multiple radiating assemblies typically sharing a common region of the ground plane, due to the distribution over the ground plane of currents associated with each radiating assembly, as described above in reference to FIG. 1.

This problem is overcome to a great extent in the multiple antenna system of embodiments of the present invention, wherein currents are concentrated in radiating assemblies 210 and 220 and at the edge of the ground plane 202 and are substantially reduced in the centre of the ground plane, as described above in reference to antenna 100. Furthermore, simulations show these currents to flow along the edge of the ground plane 202 to which each radiating assembly is adjacent and to substantially decrease before reaching the opposite edge of the ground plane to which the other radiating assembly is adjacent. Radiating assemblies 210 and 220 therefore excite currents in substantially non-overlapping portions of the common ground plane 202. As a result of this effective division of the common ground plane 202, when one of radiating assemblies 210 and 220 is excited by way of feed point 232 or 234 respectively, only a minimal current is induced on the other non-excited radiating assembly, which minimal current has a corresponding minimal net effect, both in terms of secondary signal radiation and mutual antenna coupling.

The isolation between radiating assemblies 210 and 220 is further increased by means of an additional mechanism responsible for suppression of induced secondary currents. When a first one of radiating assemblies 210 or 220 is excited, a current may be induced in the second, non-excited, radiating assembly. However, simulations have shown that the current induced in the coupling element of the non-excited radiating assembly is partly cancelled by a parallel current flowing in the opposite direction along the proximate edge of the ground plane 202. The net current induced in the non-excited radiating assembly is therefore lowered.

The enhanced isolation between radiating assemblies 210 and 220 makes multiple antenna system 200 particularly well suited for MIMO applications and for meeting 3GPP Long Term Evolution (LTE) communication standards.

Isolation between radiating assemblies 210 and 220 may be maximized by increasing the respective distances between feed element 224 and feed element 228 and the ground plane 202. Isolation may also be improved by decreasing the separation between feed element 224 and coupling element 226 in radiating assembly 210 and the separation between feed element 228 and coupling element 230 in radiating assembly 220. Isolation between, the radiating assemblies has also been found to improve as the lengths of the feed and coupling elements of each radiating assembly converge. However, this improvement in isolation may be at the expense of the operating bandwidth of the radiating assemblies.

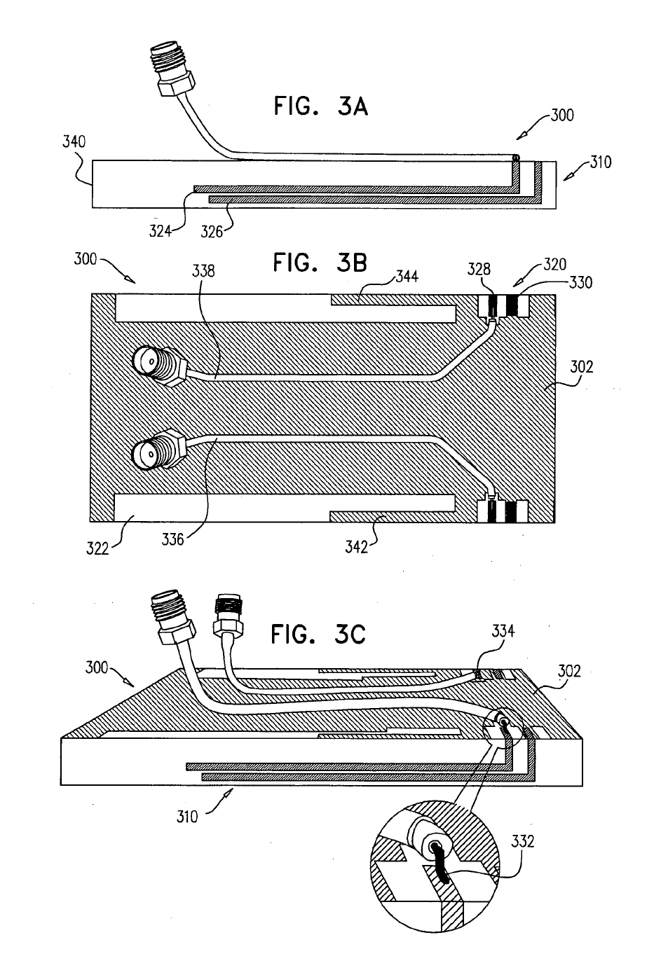

Reference is now made to FIGS. 3A, 3B and 3C which are simplified respective side, top and perspective view illustrations of a multiple antenna system, constructed and operative in accordance with another preferred embodiment of the present invention.

As seen in FIGS. 3A-3C there is provided a multiple antenna system 300 including a ground plane 302, in proximity to an edge of which ground plane 302 are preferably located at least two radiating assemblies 310 and 320. It is appreciated that although in the embodiment illustrated in FIGS. 3A-3C only two radiating assemblies 310 and 320 are shown, the present invention as illustrated in FIGS. 3A-3C may be easily modified by one skilled in the art to include a greater number of radiating assemblies located in proximity to ground plane 302. Ground plane 302 is preferably formed on the surface of a rigid PCB substrate 322 such as FR-4.

Each of radiating assemblies 310 and 320 preferably comprises a pair of feed and coupling elements of a type generally similar to those included in antenna 100 and in radiating assemblies 210 and 220 of multiple antenna system 200. Radiating assembly 310 thus includes a conductive feed element 324 and a conductive coupling element 326 and radiating assembly 320 includes a conductive feed element 328 and a conductive coupling element 330. Feed element 324 is preferably fed at a feed point 332 and feed element 328 is preferably fed at a feed point 334, which feed points 332 and 334 are preferably respectively connected to two transmission lines 336 and 338. By way of example in FIGS. 3A-3C, transmission lines 336 and 338 are shown to be in the form of coaxial cables. However, the use of any appropriate transmission line structure is possible. It is appreciated that feed element 328 is preferably connected to transmission line 338 in a similar fashion to the connection of feed element 324 to transmission line 336, seen most clearly in the balloon in FIG. 3C.

Radiating assemblies 310 and 320 are preferably located adjacent to opposite edges of ground plane 302, such that the radiating assemblies 310 and 320 face each other across the width of ground plane 302. Ground plane 302 thus acts as a common ground plane for both of radiating assemblies 310 and 320.

Multiple antenna system 300 may resemble multiple antenna system 200 in every relevant respect, with the exception of the geometry of the radiating assemblies. Whereas multiple antenna system 200 has planar geometry, with radiating assemblies 210 and 220 preferably lying in the same plane as ground plane 202, multiple antenna system 300 has three-dimensional geometry, with radiating assemblies 310 and 320 preferably being positioned perpendicular to ground plane 302. Radiating assemblies 310 and 320 are preferably mounted on a plastic carrier 340. The pairs of feed and coupling elements 324 and 326, 328 and 330 of each radiating assembly may be mounted on an external surface of the plastic carrier 340, as seen most clearly in FIG. 3A. Alternatively, one of each pair of feed and coupling elements 324 and 326, 328 and 330 may be mounted on an internal surface of the plastic carrier 340. The latter design may improve the coupling between the feed and coupling elements of each pair, by facilitating their closer placement.

The three-dimensional structure of multiple antenna system 300 is advantageous in comparison to the two-dimensional structure of multiple antenna system 200 in that it allows a greater degree of freedom in adding more resonating elements and increases the volume of the antennas, thereby increasing their bandwidth response.

Radiating assemblies 310 and 320, in conjunction with ground plane 302, may operate as multi-band antennas, by means of the addition of high-band elements on the base of the antenna. As seen most clearly in FIG. 3B, two high-band elements 342 and 344, preferably respectively located in proximity to radiating assemblies 310 and 320, extend outwards from either side of ground plane 302. High-band elements 342 and 344 allow radiating assemblies 310 and 320 to each operate in a high frequency band of approximately 1.7-2.2 GHz, in addition to their low frequency band of approximately 698-960 MHz. A particular advantage of the antenna system of the present invention is that the high-band operating frequencies and low-band operating frequencies are preferably mutually independent. This is in contrast to conventional multi-band antennas, in which the frequencies of multiple operating bands are typically inter-dependent.

High-band elements 342 and 344 are preferably respectively provided for each of radiating assemblies 310 and 320. However, it is appreciated that the provision of a high-band element for only one of the radiating assemblies is also possible, whereby one radiating assembly will operate as a multi-band antenna and one as a single-band antenna. Similarly, it is appreciated that although the high-band elements 342 and 344 are shown as identical in FIG. 3B, they may alternatively differ from one and other in length, thickness or any other relevant parameter, according to operating requirements.

Other advantages and operational details of multiple antenna system 300, including improved isolation between radiating assemblies 310 and 320 due to their separate current paths on the ground plane and cancellation of currents induced in one radiating assembly as a result of excitation of the other, are as outlined above in reference to multiple antenna system 200. Simulations have found the isolation between the radiating assemblies in multiple antenna system 300 to be better than −10 dB, meaning that less than 10% of the signal transmitted by one of the radiating assemblies is coupled to the neighbouring radiating assembly.

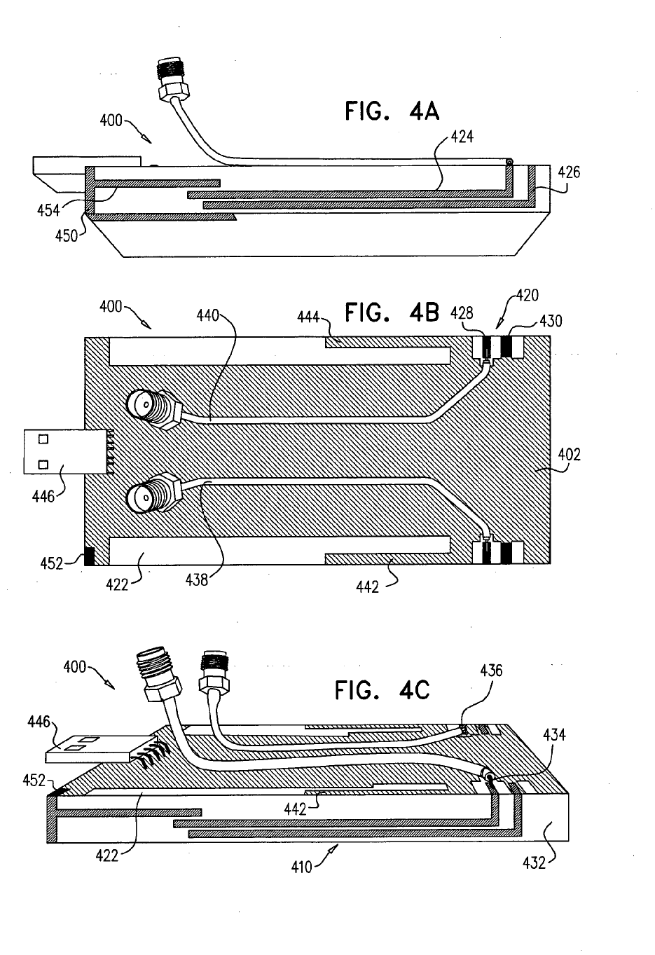

Reference is now made to FIGS. 4A, 4B and 4C, which are simplified respective underside, top and perspective view illustrations of a multiple antenna system constructed and operative in accordance with yet another preferred embodiment of the present invention.

As seen in FIGS. 4A-4C, there is provided a multiple antenna system 400, including a ground plane 402, in proximity to an edge of which ground plane 402 are preferably located at least two radiating assemblies 410 and 420. Ground plane 402 is preferably formed on a surface of a rigid PCB substrate 422 such as FR-4.

Each of radiating assemblies 410 and 420 preferably comprises a pair of feed and coupling elements generally similar in their structure and operation to those included in radiating assemblies 310 and 320 of FIGS. 3A-3C. Radiating assembly 410 thus includes a conductive feed element 424 and a conductive coupling element 426 and radiating assembly 420 includes a conductive feed element 428 and a conductive coupling element 430. The pairs of feed and coupling elements 424 and 426, 428 and 430 are preferably mounted on a surface of a plastic carrier 432.

Feed elements 424 and 428 are preferably respectively fed at two feed points 434 and 436, which feed points 434 and 436 are preferably respectively connected to two transmission lines 438 and 440. Two high-band elements 442 and 444 preferably extend outwards from ground plane 402, allowing radiating assemblies 410 and 420 to operate, in conjunction with ground plane 402, as multi-band antennas radiating in both low and high frequency bands.

Multiple antenna system 400 may optionally be built in the form of a Universal Serial Bus (USB) dongle, with one end 446 of the ground plane 402 adapted for insertion into a USB port, as seen most clearly in FIGS. 4B and 4C. This allows multiple antenna system 400 to be connected to a computer through a USB interface, so as to provide wireless Local Area Network (LAN) connectivity. It will be apparent to one skilled in the art that although only multiple antenna system 400 is shown in the form of a USB dongle, the other multiple antenna systems described herein may easily be adapted to be of the same form.

It is a particular feature of multiple antenna system 400 that the system includes an additional conductive element 450, preferably located at a corner 452 of ground plane 402 and galvanically connected to it. Conductive element 450 branches into a conductive arm 454 and then wraps around the upper surface of plastic carrier 432, as seen most clearly in FIG. 4A. Conductive arm 454 is preferably spaced apart from and overlapping with feed element 424, so that capacitive coupling occurs between the overlapping portions of the arm 454 and the feed element 424. This capacitive coupling serves to widen the low frequency bandwidth of radiating assembly 410.

It is appreciated that although, for simplicity, the additional conductive element 450 is shown only in proximity to radiating assembly 410, a second conductive element may be added in proximity to radiating assembly 420.

Other advantages and operational details of multiple antenna system 400, including improved isolation between radiating assemblies 410 and 420 due to their separate current paths on the ground plane 402 and cancellation of currents induced in one radiating assembly as a result of excitation of the other, are as described above in reference to multiple antenna systems 200 and 300.

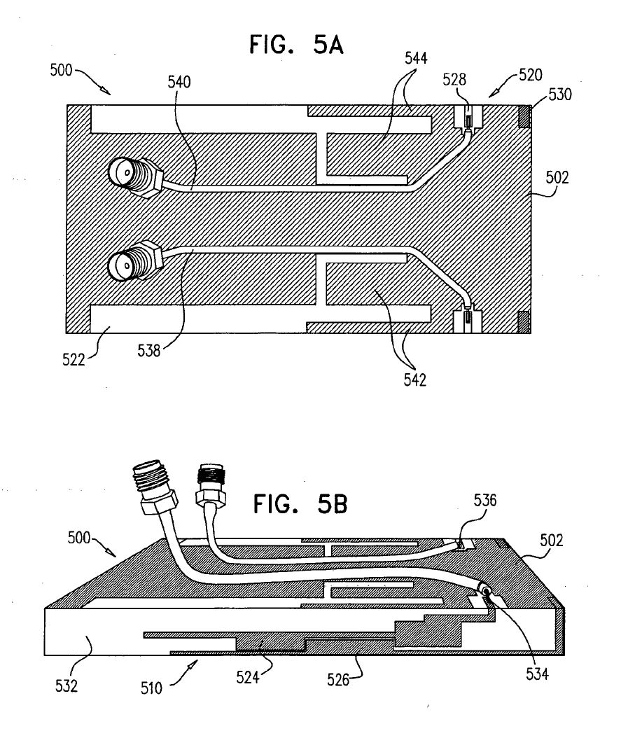

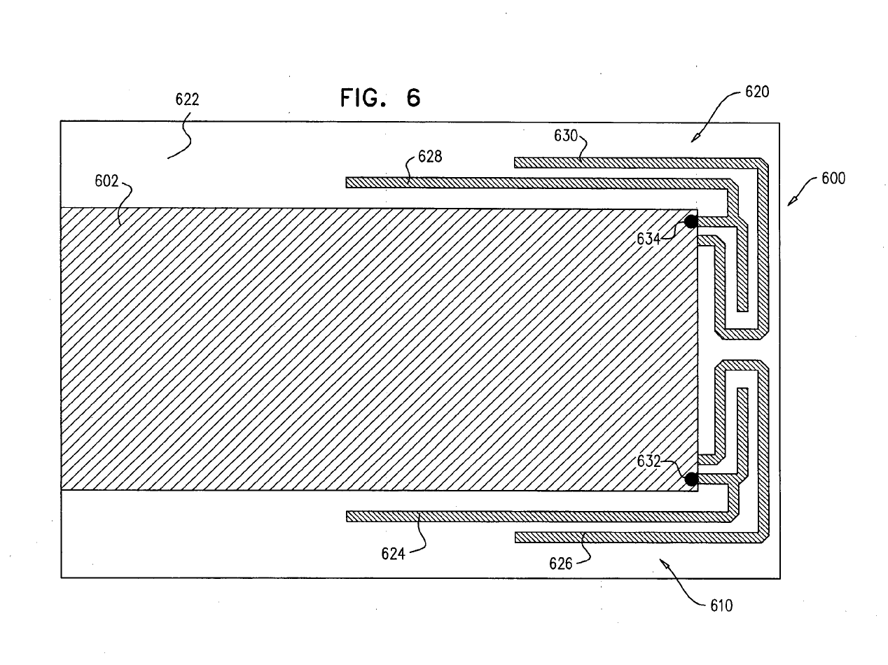

Reference is now made to FIGS. 5A and 5B, which are simplified respective top and perspective view illustrations of a multiple antenna system, constructed and operative in accordance with still another preferred embodiment of the present invention.

As seen in FIGS. 5A and 5B, there is provided a multiple antenna system 500. Multiple antenna system 500 generally resembles multiple antenna system 300 in its structure and operation, with the exception of certain features detailed below. Multiple antenna system 500 includes a common ground plane 502 and two radiating assemblies 510 and 520. The common ground plane 502 is preferably formed on a surface of a PCB substrate 522 such as FR-4.

Radiating assembly 510 comprises a feed element 524 and a coupling element 526 and radiating assembly 520 comprises a feed element 528 and a coupling element 530. The pairs of feed and coupling elements 524 and 526, 528 and 530 are preferably mounted on a surface of a plastic carrier 532. Feed elements 524 and 528 are preferably respectively fed at feed points 534 and 536, which feed points 534 and 536 are preferably respectively connected to two transmission lines 538 and 540. As seen most clearly in FIG. 5A, two multiple high-band conductive elements 542 and 544 preferably extend outwards from the edges of ground plane 502. The inclusion of multiple high-band elements 542 and 544, rather than a single high-band element as in multiple antenna systems 300 and 400, serves to widen the radiating bandwidth of radiating assemblies 510 and 520 in both the low and high frequency bands.

It is a particular feature of the embodiment of the invention shown in FIGS. 5A and 5B that the widths of feed and coupling elements 524 and 526 are non-uniform, as seen most clearly in FIG. 5B. This variation in width influences the ratio of the inductive to capacitive coupling between coupling element 526 and feed element 524, whereby the low and high operating bandwidths of radiating assembly 510 may be optimized.

Other advantages and operational details of multiple antenna system 500, including improved isolation between radiating assemblies 510 and 520 due to their separate current paths on the ground plane 502 and cancellation of currents induced in one radiating assembly as a result of excitation of the other, are as outlined above in reference to multiple antenna system 300.

Reference is now made to FIG. 6, which is a schematic illustration of a multiple antenna system constructed and operative in accordance with another preferred embodiment of the present invention.

As seen in FIG. 6, there is provided a multiple antenna system 600, including a ground plane 602 and two radiating assemblies 610 and 620. Ground plane 602 and radiating assemblies 610 and 620 are preferably formed as planar elements on a surface of a PCB substrate 622, such as FR-4.

Radiating assembly 610 includes a first branched feed element 624 and a first coupling element 626 folded around branched feed element 624 and radiating assembly 620 includes a second branched feed element 628 and a second coupling element 630 folded around branched feed element 628. First and second branched feed elements 624 and 628 are preferably respectively fed at feed points 632 and 634. First and second coupling elements 626 and 630 are preferably connected at at least one end to ground plane 602.

Features of multiple antenna system 600 generally resemble those of multiple antenna system 200, with the exception of the branched configuration of feed elements 624 and 628. The branched nature of feed elements 624 and 628 allows radiating assemblies 610 and 620 to operate, in conjunction with ground plane 602, as multi-band antennas, as opposed to the single-band antennas of multiple antenna system 200. Thus, no additional high-band radiating element is required by radiating assemblies 610 and 620. This is contrast to the antenna systems illustrated in FIGS. 3A-5B, in which separate high-band elements extending from the ground plane are preferably provided.

Other advantages and operational details of multiple antenna system 600, including improved isolation between radiating assemblies 610 and 620 due to their separate current paths on the ground plane 602 and cancellation of currents induced in one radiating assembly as a result of excitation of the other, are as outlined above in reference to multiple antenna system 200. Simulations have found the isolation between the two radiating assemblies in multiple antenna system 600 to be better than −10 dB, meaning that less than 10% of the signal transmitted by one of the radiating assemblies is coupled to its neighbouring radiating assembly.

### Simulation Results

In this section, simulated data generated for a multiple antenna system, constructed and operative in accordance with the embodiment of the invention illustrated in FIGS. 5A and 5B, are presented. It is appreciated that the results obtained are representative of the performance of a multiple antenna system constructed in accordance with any one of the embodiments of the present invention described above.

### Details of Model

The dimensions of the PCB were 50 mm by 100 mm. The PCB substrate comprised FR-4, with a dielectric constant of 4.4. The radiating assemblies were mounted perpendicular to the PCB on a plastic carrier with a dielectric constant of 3.14. The dimensions of each of the radiating assemblies, including both the feed and coupling arms, were 68 mm by 9 mm. Each radiating assembly was fed at a feed point connected to a coaxial cable transmission line. The resonant frequencies of the system were 925 MHz (low-band) and 1990 MHz (high-band).

The radiation pattern, electric field distribution, terminal efficiency, return gain and isolation of the above-described system were simulated using Ansoft HFSS software, version 12.

### Radiation Pattern

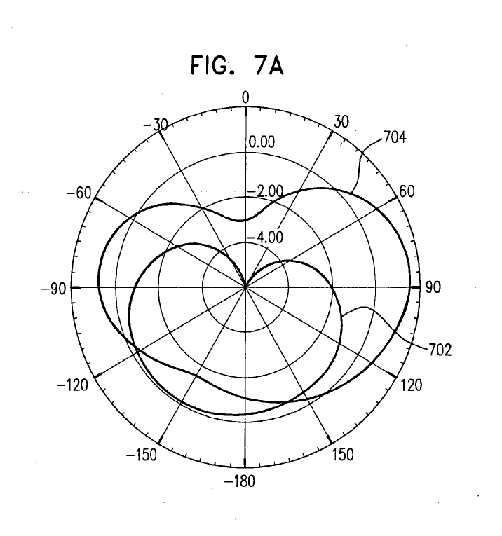

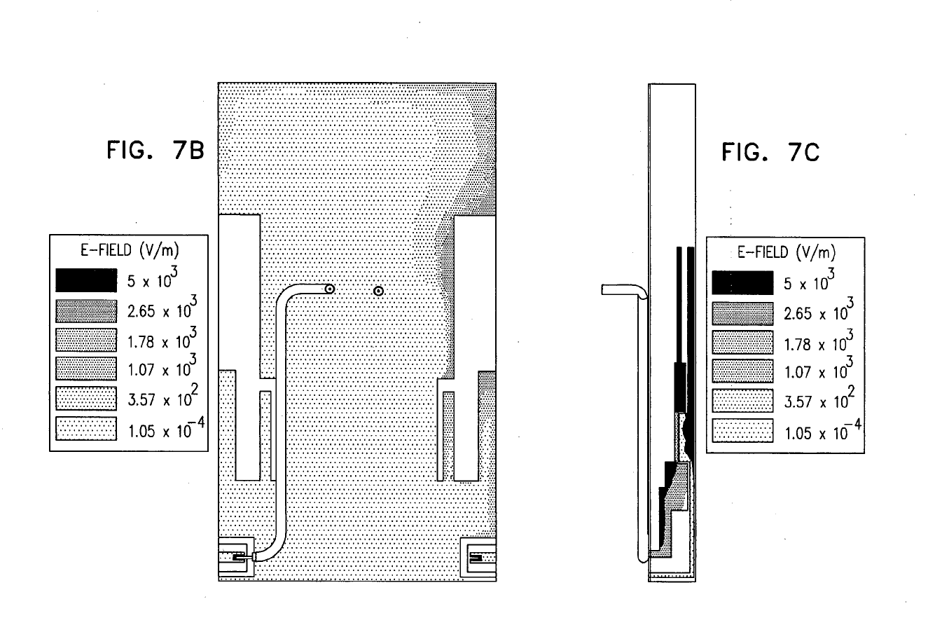

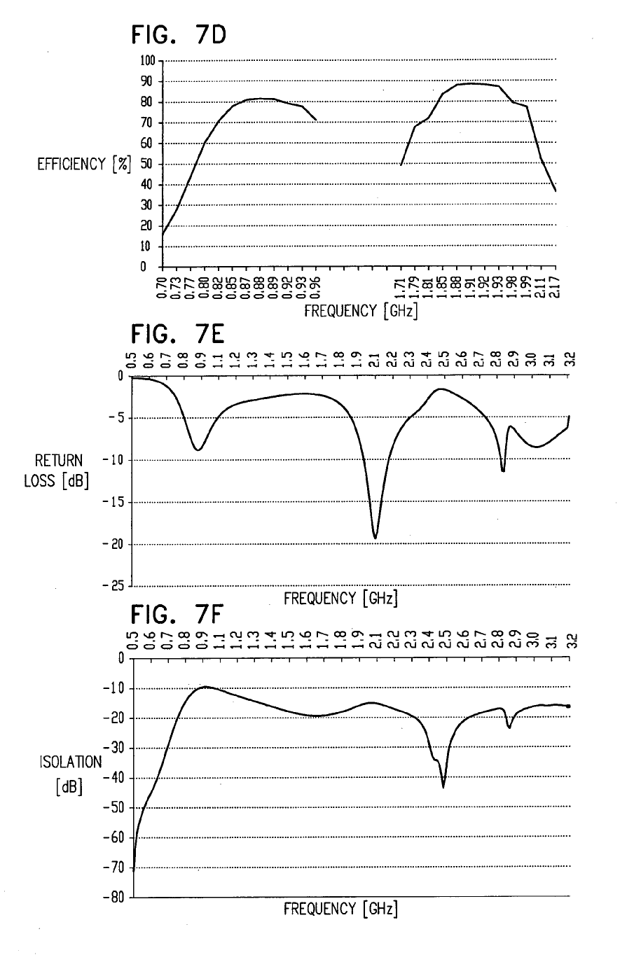

Reference is now made to FIG. 7A, which is a simplified graph showing a radiation pattern of an antenna in a multiple antenna system of the type illustrated in FIGS. 5A and 5B. A curve 702 represents the simulated radiation pattern of the antenna at 925 MHz and a curve 704 represents the simulated radiation pattern of the antenna at 1990 MHz. As is evident from their non-circular shape, the radiation patterns are directional and thus differ significantly from the omnidirectional dipole-like radiation patterns typically associated with antennas in handheld devices.

### Electric Field Distribution

Reference is now made to FIGS. 7B and 7C, which are simplified respective top and side view illustrations of an electric field distribution of an antenna in a multiple antenna system of the type illustrated in FIGS. 5A and 5B. It is appreciated that although one coaxial cable is shown as having been removed from the PCB in FIGS. 7B and 7C, this is only for presentation purposes, so as not to obscure the view of the electrical field distribution.

The simulated near electric field at 925 MHz is seen to be highly localized in the region of the excited feed element and its associated coupling element, as seen most clearly in FIG. 7C, and to significantly decrease towards the centre of the ground plane and the edge of the ground plane opposite to the excited radiating assembly, as seen most clearly in FIG. 7B. This electric field distribution is markedly different from that associated with conventional antennas for handheld devices, in which currents typically travel back and forth along the ground plane. The concentration of the electric field at the edge of the ground plane is thought to be one of the mechanisms responsible for the enhanced isolation exhibited between the co-located antennas of the present invention.

### Terminal Efficiency, Return Loss and Isolation

Reference is now made to FIGS. 7D, 7E and 7F which are simplified graphs respectively showing the efficiency, return loss and isolation of an antenna in a multiple antenna system of the type illustrated in FIGS. 5A and 5B.

As seen in FIG. 7D, peak antenna efficiency is over 80% in both the low and high frequency bands. It should be kept in mind when considering the return losses of the antenna, as seen in FIG. 7E, that the antenna does not include a matching circuit. By adding a matching circuit, the antenna has potential to cover the LTE 700 MHz, GSM 850/900 and 1800/1900 MHz and WCDMA 2100 MHz bands. Due to the good isolation of the antenna, as seen in FIG. 7F, the antenna is ideally suited to support MIMO applications such as LTE and HSPA+ in these frequency bands.

It will be appreciated by persons skilled in the art that the present invention is not limited by what has been particularly claimed hereinbelow. Rather, the scope of the invention includes various combinations and subcombinations of the features described hereinabove as well as modifications and variations thereof as would occur to persons skilled in the art upon, reading the forgoing description with reference to the drawings and which are not in the prior art. In particular, it will be appreciated that more than one of the different types of antennas described hereinabove may be included in one multiple antenna system. Similarly, it will be appreciated that any one of the different types of antennas described hereinabove as included in a multiple antenna system may alternatively be employed as a single antenna.

1. An antenna, comprising:
a ground plane;
at least one first conductive element located in proximity to an edge of said ground plane and having first and second ends, said first end extending generally parallel to said ground plane, said second end in contact with a feed point; and at least one second conductive element located in proximity to said edge of said ground plane and having first and second ends, said first end extending generally parallel to said ground plane and to said first end of said at least one first conductive element, said second end in contact with said ground plane.

2. An antenna according to claim 1, wherein said at least one first conductive element comprises a folded monopole.

3. An antenna according to claim 1, wherein said at least one second conductive element comprises a parasitic element in capacitive and inductive contact with said at least one first conductive element.

4. An antenna according to claim 1, wherein said contact between said second end of said at least one second conductive element and said ground plane comprises a galvanic contact.

5. An antenna according to claim 1, wherein said at least one first and second conductive elements comprise strips of conductive material, said strips having a width and a length.

6. (canceled)

7. An antenna according to claim 5, wherein said width varies along said length.

8. An antenna according to claim 1, wherein said feed point is located at said edge of said ground plane.

9. An antenna according to claim 1, wherein said ground plane and said at least one first and second conductive elements are formed on a surface of a dielectric substrate.

10. (canceled)

11. An antenna according to claim 1, wherein an impedance of said second end of said at least one first conductive element matches a 50 Ohm input impedance.

12. An antenna according to claim 11, wherein said antenna does not comprise a matching network.

13. An antenna according to claim 1, wherein an electric field generated by currents on said ground plane is concentrated at edges of said ground plane.

14. A multiple antenna system comprising at least two of the antennas of claim 1, wherein said ground plane comprises a common ground plane.

15. A multiple antenna system according to claim 14, wherein said multiple antenna system comprises a MIMO system.

16. A multiple antenna system according to claim 15, wherein said multiple antenna system comprises a 3GPP-LTE system.

17-18. (canceled)

19. A multiple antenna system according to claim 14, wherein said at least one first and second conductive elements are mounted on a plastic carrier.

20-21. (canceled)

22. A multiple antenna system according to claim 14 and also comprising at least one conductive element extending from said common ground plane, whereby at least one antenna in said multiple antenna system is capable of resonating in two mutually independent frequency bands.

23. A multiple antenna system according to claim 22, wherein said two frequency bands comprise a high frequency band comprising frequencies between 1.7 and 2.2 GHz and a low frequency band comprising frequencies between 698 and 960 MHz.

24-27. (canceled)

28. A multiple antenna system according to claim 14, and also comprising at least one conductive element galvanically connected to said ground plane and in capacitive contact with said first end of said at least one first conductive element, whereby a bandwidth of at least one frequency band of said antenna is widened.

29. A multiple antenna system according to claim 14, wherein said at least one first conductive element comprises a branched conductive element and said at least one second conductive element is folded around said branched conductive element.

30. (canceled)

31. A method for impedance matching, comprising:
providing a ground plane;
providing at least one first conductive element located in proximity to an edge of said ground plane and having a first end and a second end, said first end extending generally parallel to said ground plane, said second end in contact with a feed point; and providing at least one second conductive element located in proximity to said edge of said ground plane and having a first end and a second end, said first end extending generally parallel to said ground plane and to said first end of said at least one first conductive element, said second end in contact with said ground plane, whereby an impedance of said second end of said at least one first conductive element is substantially increased.

32-34. (canceled)
